(19) United States
(12) Patent Application Publication
(10) Pub. No.: US 2024/0029692 A1
(43) Pub. Date: Jan. 25, 2024

(54) SOUND OUTPUT SYSTEM

(71) Applicant: YAMAHA CORPORATION, Hamamatsu-shi (JP)

(72) Inventors: Haruki UEHARA, Hamamatsu-shi (JP); Haruki OHKAWA, Hamamatsu-shi (JP)

(21) Appl. No.: 18/341,174

(22) Filed: Jun. 26, 2023

(30) Foreign Application Priority Data
Jul. 21, 2022 (JP) 2022-116646

(51) Int. Cl. G10H 1/00; G10H 1/04; G10F 1/02

(52) U.S. Cl. CPC G10H 1/0008; G10H 1/0066; G10H 1/04; G10F 1/02; G10H 2240/311; G10H 2210/281

(57) ABSTRACT

A sound output system according to an embodiment includes a speaker configured to output a sound according to sound data supplied to the speaker, and an operation device comprising one or more operators, a drive unit configured to drive the one or more operators based on performance data supplied to the operation device in synchronization with the sound data supplied to the speaker, and a drive control unit configured to control the drive unit. According to the output system, it is possible to faithfully reproduce a performance sound at the time of performance and to accurately reproduce a performance at the time of performance by driving at operator based on the performance sound.

### CROSS-REFERENCE TO RELATED APPLICATIONS

This application claims the benefit of priority to Japanese Patent Application No. 2022-116646, filed on Jul. 21, 2022, the entire contents of which are incorporated herein by reference.

### FIELD

The present disclosure relates to a sound output system.

### BACKGROUND

So-called self-playing pianos are known which generate sounds based on MIDI data and drive a keyboard without striking. For example, Japanese laid-open patent publication No. H08-292765 discloses a self-playing piano that can be performed synchronously via a network. Japanese laid-open utility model publication No. H05-052869 discloses a performance operation device that can be performance operated based on MIDI standard performance operation information transmitted via a network.

### SUMMARY

According to an embodiment of the present disclosure, there is provided a sound output system including: a speaker configured to output a sound according to sound data supplied to the speaker; and an operation device comprising one or more operators; a drive unit configured to drive the one or more operators based on performance data supplied to the operation device in synchronization with the sound data supplied to the speaker; and a drive control unit configured to control the drive unit.

### BRIEF DESCRIPTION OF DRAWINGS

FIG. 1 is a schematic view of a sound output system according to an embodiment of the present disclosure.

FIG. 2 is a block diagram showing a configuration of a speaker device according to an embodiment of the present disclosure.

FIG. 3 is a perspective view showing an example of an operation device according to an embodiment of the present disclosure.

FIG. 4 is a diagram illustrating an inner structure of a keyboard device.

FIG. 5 is a diagram showing a configuration of a control device of a keyboard device.

FIG. 6 is a block diagram showing a configuration of a supply unit according to an embodiment of the present disclosure.

FIG. 7 is a diagram showing a functional configuration of a control unit of a supply unit.

FIG. 8 is a block diagram showing a configuration of a server according to an embodiment of the present disclosure.

FIG. 9 is a block diagram showing a configuration of a performance data generation unit.

FIG. 10 is a block diagram showing a configuration of a speaker device according to a modification of an embodiment of the present disclosure.

### DESCRIPTION OF EMBODIMENTS

According to the techniques disclosed in Japanese laid-open patent publication No. H08-292765 and Japanese laid-open utility model publication No. H05-052869, auto play can be performed on a keyboard device based on MIDI data. On the other hand, since a performance sound is once converted into MIDI data, the faithful reproducibility of the performance sound itself at the time of performance is poor.

According to the present disclosure, it is possible to faithfully reproduce a performance sound at the time of performance and to accurately reproduce a performance at the time of performance by driving an operator based on the performance sound.

Hereinafter, a sound output system according to an embodiment of the present disclosure will be described in detail with reference to the drawings. The following embodiments are examples of embodiments of the present disclosure, and the present disclosure is not to be construed as being limited to these embodiments. In addition, in the drawings referred to in the present embodiment, the same parts or parts having similar functions are denoted by the same reference sign or similar reference sign (only denoted by A, B, and the like after the numerals), and repeated description thereof may be omitted.

### [Overall Configuration of Sound Output System]

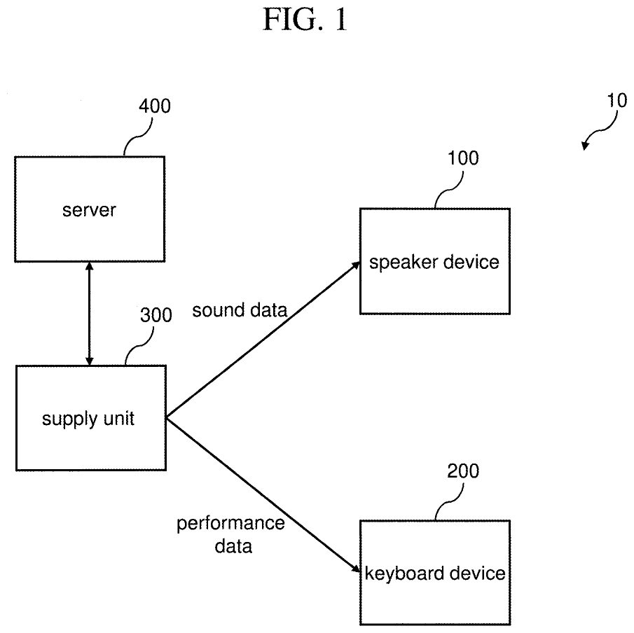

FIG. 1 is a schematic configuration diagram of a sound output system 10 according to an embodiment of the present disclosure. The sound output system 10 includes a speaker device 100, a keyboard device 200, a supply unit 300, and a server 400.

### [1. Configuration of Speaker Device]

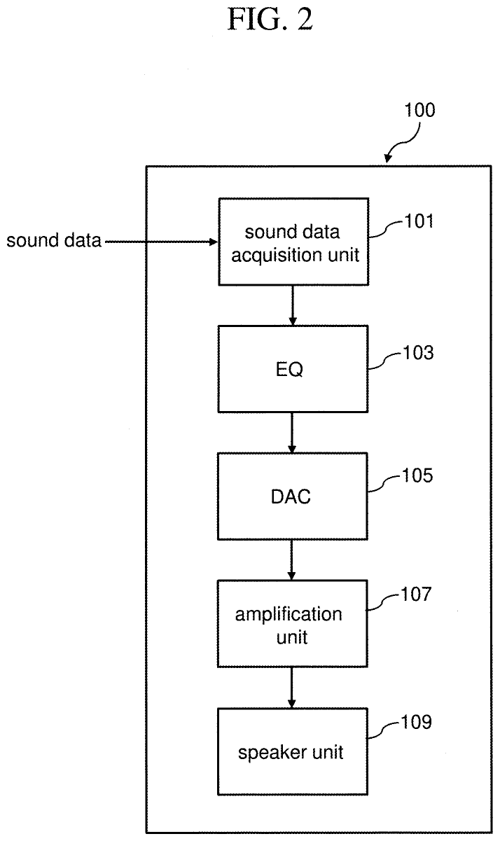

The speaker device 100 outputs a sound according to sound data. The sound data is supplied from the supply unit 300 to the speaker device 100. The sound data is data indicating an audio signal that has been subjected to a reverb removal processing from music data indicating the sound content of the music. FIG. 2 is a block diagram showing a configuration of the speaker device 100. Referring to FIG. 2, the speaker device 100 includes a sound data acquisition unit 101, an equalizer (EQ) 103, a D/A converter (DAC) 105, an amplification unit 107, and a speaker unit 109.

The sound data acquisition unit 101 acquires sound data from the supply unit 300. The sound data acquisition unit 101 supplies the acquired sound data to the equalizer 103. The equalizer 103 adjusts frequency characteristic of the sound data supplied from the sound data acquisition unit 101, and outputs the adjusted sound data to the D/A converter 105.

The D/A converter 105 converts the sound data whose frequency characteristic is adjusted by the equalizer 103 from a digital signal to an analog signal, and output the analog signal to the amplification unit 107. The amplification unit 107 amplifies the analog-converted sound data according to a set amplification factor, and outputs the sound data to the speaker unit 109.

The speaker unit 109 is a member that emits sound. The speaker unit 109 may be an electromagnetic speaker unit, but is not limited to this. The speaker unit 109 emits sound based on the sound data supplied from the amplification unit 107. The sound data may be supplied as streaming data.

### [2. Configuration of Keyboard Device]

The keyboard device 200 includes a plurality of keys as one or more operators, a key drive unit, and a key drive control unit. The key drive unit drives the plurality of keys based on performance data. The key drive control unit controls the operation of the key drive unit. The performance data is MIDI data. The performance data includes performance event information including note-on and note-off defined on a time axis which is determined depending on a tempo and duration (gate time) and pitch information indicating a pitch of the sound content. The pitch information corresponds to a key number. The performance data corresponds to the sound data, and is supplied from the supply unit 300 to the keyboard device 200 in synchronization with the sound data supplied to the speaker device 100.

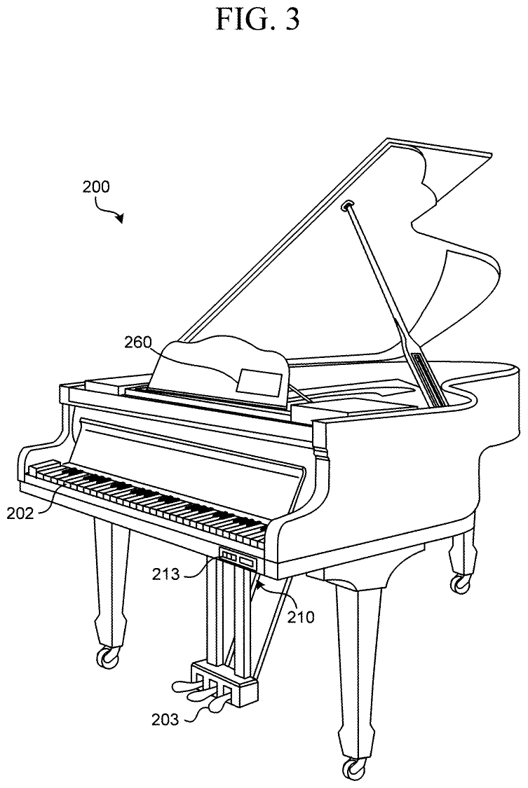

FIG. 3 is a perspective view showing an example of the keyboard device 200 according to the present embodiment. The keyboard device 200 is a keyboard musical instrument having a keyboard in which a plurality of keys 202 operated by a player are arranged on a front surface thereof, and a pedal 203. Although there is a plurality of pedals of the keyboard device 200, the pedal 203 indicates a damper pedal. In addition, the keyboard device 200 includes a control device 210 having an operation panel 213 on a front surface portion, and a touch panel 260 arranged on a music stand portion.

User's instruction can be input to the control device 210 by operating the operation panel 213 and the touch panel 260. The keyboard device 200 has a plurality of operation modes. The keyboard device 200 controls operations of each element of the keyboard device 200 based on the operation mode set based on the user's instruction. The operation mode includes a mode in which the sound generated regardless of the driving of the key 202 is output from the speaker device 100. Details of each operation mode will be described later.

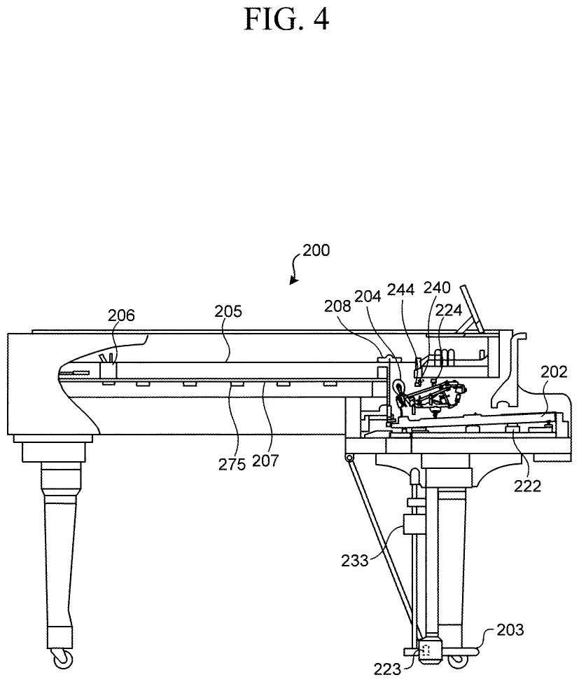

FIG. 4 is a diagram illustrating an inner structure of the keyboard device 200. In FIG. 4, a configuration arranged corresponding to each key 202 indicates each configuration arranged corresponding to one key 202 (a white key in this example) shown in the figure, and a description of each configuration arranged corresponding to another key 202 is omitted.

A key drive unit 230 configured to drive the key 202 by using a solenoid is arranged below a rear end side of the key 202 (a rear side of the key 202 as viewed from the user who plays the keyboard device 200). The key drive unit 230 drives the solenoid in response to a key control signal based on the performance data supplied from the supply unit 300. The key drive unit 230 reproduces the same state as when the user presses the key by driving the solenoid to raise the plunger, and reproduces the same state as when the user releases the key by lowering the plunger.

A hammer 204 is arranged corresponding to each key 202, and when the key 202 is pressed, a force is transmitted to the hammer 204 through an action mechanism 245 and the hammer 204 moves to hit a string 205 arranged corresponding to each key 202. The string 205 is a sound generating body that generates sound by hitting the hammer 204. Each string 205 has an oscillation frequency corresponding to each key 202.

A damper 208 is moved by a damper operation mechanism 280. The damper operation mechanism 280 moves the damper 208 so as to control a contact state between the damper 208 and the string 205 according to a press amount of the key 202 and a depression amount of the pedal 203. The control of the contact state means that the damper 208 is moved in a range from a position where the damper 208 and the string 205 contact with each other to suppress vibration of the string 205 (vibration damping position) to a position where the string 205 is released from the damper 208 (release position).

In addition, in the present embodiment, it is assumed that each of all 88 keys 202 of the keyboard device 200 has the damper 208, respectively. However, the keyboard device 200 may have a configuration, such as a typical piano, in which the damper 208 is provided for each of the keys from the key corresponding to the lowest note to 66th or 70th key respectively, and the higher-pitched keys 202 do not have the damper 208.

A stopper 240 is a member that collides with a hammer shank to prevent the hammer 204 from hitting the string 205 before striking in the case where the setting applied to the operation mode is a predetermined setting. The stopper 240 moves to either a position where it collides with the hammer shank (hereinafter referred to as a blocking position) or a position where it does not collide with the hammer shank (hereinafter referred to as a retracting position) according to a stopper control signal from the control device 210.

A stopper drive unit 244 may be a motor that is driven according to the stopper control signal from the control device 210 when the setting applied to the operation mode is a predetermined setting. The stopper drive unit 244 moves the stopper 240 to either the blocking position or the retracting position.

A key sensor 222 is arranged below the key 202 and outputs a detection signal corresponding to a behavior of the key 202 to the control device 210. In this example, the key sensor 222 detects the press amount of the key 202 in a continuous amount, and outputs a detection signal indicating a detection result to the control device 210. In addition, instead of outputting the detection signal corresponding to the press amount of the key 202, the key sensor 222 may output a detection signal indicating that the key 202 has passed through a specific press position. The specific press position is any position in the range from the rest position to the end position of the key 202, and is desirably a plurality of positions. The detection signal output by the key sensor 222 may be any signal as long as the control device 210 can recognize the behavior of the key 202.

A hammer sensor 224 is arranged corresponding to the hammer 204, and outputs a detection signal corresponding to a behavior of the hammer 204 to the control device 210. In the present embodiment, the hammer sensor 224 detects a moving velocity of the hammer 204 just before the string 205 is struck by the hammer 204, and outputs a detection signal indicating the detected velocity to the control device 210. The detection signal does not necessarily indicate the moving velocity of the hammer 204 itself, and for example, the detection signal may be a detection signal indicating the behavior of the hammer 204 other than the moving velocity so that the moving velocity may be calculated by the control device 210 in another aspect. The detection signal output by the hammer sensor 224 may be any signal as long as the control device 210 can recognize the behavior of the hammer 204.

A pedal sensor 223 is arranged corresponding to each pedal 203, and outputs a detection signal corresponding to a behavior of the pedal 203 to the control device 210. In this example, the pedal sensor 223 detects the depression amount of the pedal 203, and outputs a detection signal indicating the detected amount to the control device 210. Instead of outputting the detection signal corresponding to the depression amount of the pedal 203, the pedal sensor 223 may output a detection signal indicating that the pedal 203 has passed through a specific press position. The specific press position may be any position in the range from the rest position to the end position of the pedal, and may be a plurality of positions. The detection signal output by the pedal sensor 223 may be any signal as long as the control device 210 can recognize the behavior of the pedal 203.

A pedal drive unit 233 is arranged corresponding to the pedal 203 and drives to press the corresponding pedal 203 according to a pedal control signal supplied from the control device 210. This mechanically reproduces the same situation as when the player depresses the pedal 203.

It is sufficient that the control device 210 can specify the hit timing of the hammer 204 with respect to the string 205 (that is, key-on timing), a hit velocity (velocity), and a vibration suppression timing of the damper 208 with respect to the string 205 (that is, key-off timing), corresponding to each key 202 (the key number) based on the detection signals output from the key sensor 222, the pedal sensor 223, and the hammer sensor 224. Therefore, the key sensor 222, the pedal sensor 223, and the hammer sensor 224 may output the detected behavior of the key 202, the pedal 203, and the hammer 204 as detection signals that is different from the above-described aspect.

A soundboard 207 is connected to a sound rib 275 and a bridge 206, and the vibration of each string 205 is transmitted to the soundboard 207 via the bridge 206.

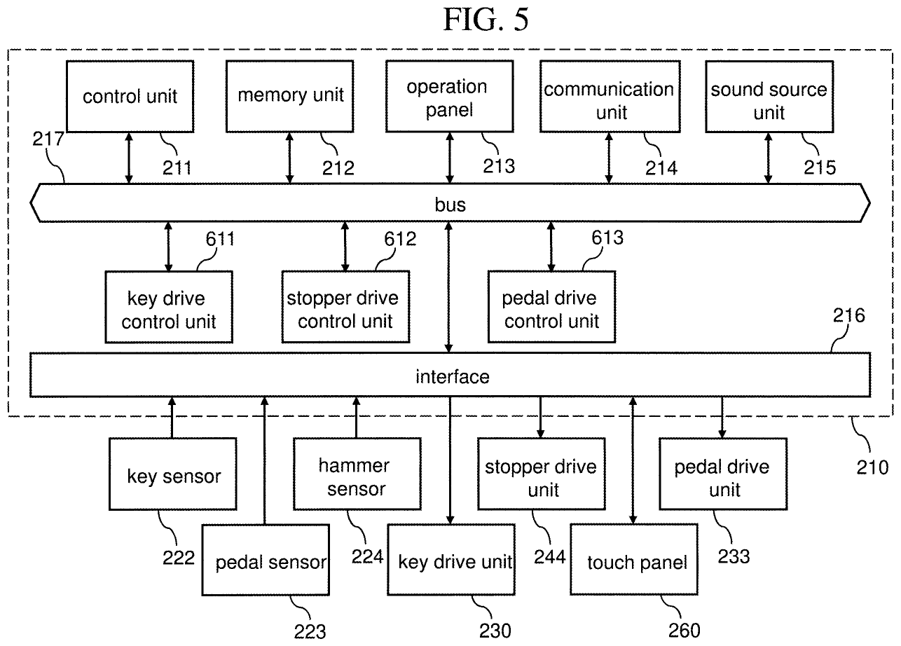

FIG. 5 is a diagram showing a configuration of the control device 210. The control device 210 includes a control unit 211, a memory unit 212, the operation panel 213, a communication unit 214, a key drive control unit 611, a stopper drive control unit 612, a pedal drive control unit 613, and an interface 216. These elements are connected via a bus 217. The control device 210 may include a sound source unit 215.

The control unit 211 has a calculation device such as a CPU (Central Processing Unit) and a memory device such as a ROM (Read Only Memory), and a RAM (Random Access Memory). The control unit 211 controls each element of the control device 210 and each element connected to the interface 216 based on a control program stored in the memory device. In this example, the control unit 211 executes the control program to cause the control device 210 and part of the elements connected to the control device 210 to function as a keyboard musical instrument. Control signals are used to control each element connected to the control device 210. For example, the control signals include the key control signal, the stopper control signal, and the pedal control signal described above. The control device 210 controls the keyboard device 200 according to the set operation mode. The operation modes that can be set in the keyboard device 200 will be described later.

The memory unit 212 stores various types of information such as setting information, music data, sound data, and performance data. The music data is data indicating an audio signal indicating sound content of the music. For example, format of the music data is format for various types of coding such as WAV and MP3. The music data includes audio information obtained at the time of recording a music, and may include sound content of one or more musical instruments. As described above, the sound data is data indicating an audio signal that has been subjected to the reverb removal processing from the music data. The performance data is MIDI data including the performance event information and the pitch information. The performance data corresponds to the sound data supplied to the speaker device 100, and the performance data and the sound data are synchronized with each other. In this case, the performance data and the sound data are synchronized with each other means that the performance data and the sound data are reproduced with the time axis aligned. In addition, the performance data is reproduced along the time axis based on the tempo and the duration time, and the sound data is reproduced according to a time stamp. The setting information indicates various settings used during the execution of the control program. For example, the setting information includes the operation mode set by the user, information indicating the setting applied in each operation mode, and the like.

The operation panel 213 includes an operation button for accepting a user's operation and the like. When the user's operation is input via the operation button, an operation signal corresponding to the operation is output to the control unit 211. The touch panel 260 connected to the interface 216 has a display screen such as a liquid crystal display, and a touch sensor operated by the user is arranged on a surface of the display screen. A setting screen for changing the contents of the setting information by performing various settings under the control of the control unit 211 via the interface 216, and various information such as a score of the set music are displayed on the display screen. In addition, when the touch panel 260 is operated by the user, the operation signal corresponding to the operation of the user is output to the control unit 211 via the interface 216. That is, an instruction from the user to the control device 210 is input by operating the operation panel 213 or the touch panel 260.

The communication unit 214 is an interface that communicates with other devices such as the speaker device 100 and the supply unit 300 wirelessly or by wire. The interface may be connected to a disk drive that reads out various data recorded in a recording medium such as a DVD (Digital Versatile Disk), a CD (Compact Disk) and outputs the read data, or may be connected to a semiconductor memory or the like, or may be connected to an external device such as a server via a network. For example, the data input to the control device 210 via the communication unit 214 may be the performance data, the music data, or the above control program.

A sound source unit 215 generates and outputs the audio signal based on an instruction from the control unit 211. Although not shown, the sound source unit 215 includes the equalizer unit that adjusts a frequency distribution of the audio signal and the amplification unit that amplifies the audio signal. For example, the sound source unit 215 may generate the audio signal according to the music data and the detection signals output from the key sensor 222, the pedal sensor 223, and the hammer sensor 224. The sound source unit 215 may include a decoding unit (not shown) that decodes the music data encoded in various formats. The audio signal generated in the sound source unit 215 is output to a terminal to which a headphone or the like is connected. In addition, in the case where the keyboard device 200 includes an exciter, the audio signal may be converted into a drive signal for driving the exciter.

The key drive control unit 611 generates the key control signal based on the performance data. The generated key control signal is output to the key drive unit 230 via the interface 216. The key drive control unit 611 may sequentially generate the key control signal based on the performance data, and may output the key control signal to the key drive unit 230. The key drive control unit 611 may generate the key control signal based on the detection signal output from the key sensor 222 and may generate the key control signal based on the music data.

The stopper drive control unit 612 generates the stopper control signal based on the performance data and a predetermined setting applied to the operation mode. The generated stopper control signal is output to the stopper drive unit 244 via the interface 216.

The pedal drive control unit 613 generates the pedal control signal based on the performance data in the case where the performance data includes information for driving the pedal. The generated pedal control signal is output to the pedal drive unit 233 via the interface 216. The pedal drive control unit 613 may generate the pedal control signal based on the detection signal output from the pedal sensor 223, or may generate the pedal control signal based on the music data.

The interface 216 is an interface for connecting the control device 210 and each of external elements. In this example, the elements connected to the interface 216 include the key sensor 222, the pedal sensor 223, the hammer sensor 224, the key drive unit 230, a stopper drive unit 244, the touch panel 260, and the pedal drive unit 233. The interface 216 outputs the detection signals output from the key sensor 222, the pedal sensor 223, and the hammer sensor 224, and the operation signal output from the touch panel 260 to the control unit 211. In addition, the interface 216 outputs the key control signal to the key drive unit 230, the stopper control signal to the stopper drive unit 244, and the pedal control signal to the pedal drive unit 233.

### [3. Description of Operation Mode]

Operation modes that can be set in the keyboard device 200 will be described. The keyboard device 200 is set by selecting one of the plurality of operation modes. The plurality of operation modes includes a manual performance mode and an auto play mode, and each operation mode may be set by the user of the keyboard device 200 using the touch panel 260 or the operation panel 213. Each operation mode and the setting content to be applied in the operation mode will be described.

### [Manual Performance Mode]

The manual performance mode is a mode set when the player operates the key 202 of the keyboard device 200 to perform. In the manual performance mode, a normal setting or a mute setting is applied to the keyboard device 200.

The normal setting is for playing the keyboard device 200 as an acoustic piano. In the case where the normal setting is applied, the stopper 240 is moved to the retracting position and the hammer 204 strikes the string 205.

On the other hand, the mute setting in the manual performance mode is a setting for playing the keyboard device 200 as an electronic piano. In the case where the mute setting is applied in the manual performance mode, the stopper 240 is moved to the blocking position and the striking of the string 205 by the hammer 204 is blocked by the stopper 240. In the mute setting, the sound source unit 215 generates the audio signal based on the detection signals output from the key sensor 222, the pedal sensor 223, and the hammer sensor 224.

### [Auto Play Mode]

The auto play mode is a mode in which the key drive unit 230 drives the key 202 based on the music data or the performance data instead of the player operating the key 202 of the keyboard device 200. In the auto play mode, an auto play setting or the mute setting is applied to the keyboard device 200.

The auto play setting is a setting that drives the keyboard device 200 as a normal self-playing piano. In the case where the auto play setting is applied, the key drive control unit 611 generates the key control signal based on the performance data. The key control signal is output to the key drive unit 230 and the key 202 is driven by the key drive unit 230 based on the key control signal. On the other hand, the stopper 240 is moved to the blocking position, and the striking of the string 205 by the hammer 204 is blocked by the stopper 240. Instead, in the sound source unit 215, the audio signal is generated based on the performance data.

The mute setting in the auto play mode is a setting in which, when the keyboard device 200 is driven as a self-playing piano, sound is output from the speaker device 100 without generating the audio signal in the sound source unit 215. In the case where the mute setting is applied in the auto play mode, the key drive control unit 611 generates the key control signal based on the performance data. As described above, the performance data is supplied from the supply unit 300 to the keyboard device 200 in synchronization with the sound data supplied to the speaker device 100. The key control signal is output to the key drive unit 230 and the key 202 is driven by the key drive unit 230. On the other hand, the stopper 240 is moved to the blocking position, and the striking of the string 205 by the hammer 204 is blocked by the stopper 240. In the mute setting in the auto play mode, the sound according to the sound data is emitted from the speaker device 100 in synchronization with the driving of the key 202 in the keyboard device 200. In addition, the speaker device 100 may emit a sound according to the music data instead of the sound according to the sound data. For example, in the case where the sound according to the music data is reproduced, a sound according to the sound data may be emitted if the reverberation sound is unnatural, and a sound according to the music data may be emitted if the reverberation sound is not unnatural. In the case where the music data is emitted, the sound data may be omitted.

### [4. Configuration of Supply Unit]

Referring back to FIG. 1, the supply unit 300 will be described. The supply unit 300 supplies the sound data to the speaker device 100, and supplies the performance data synchronized with the sound data to the keyboard device 200. The performance data is supplied to the key drive control unit 611 and the pedal drive control unit 613 of the keyboard device 200.

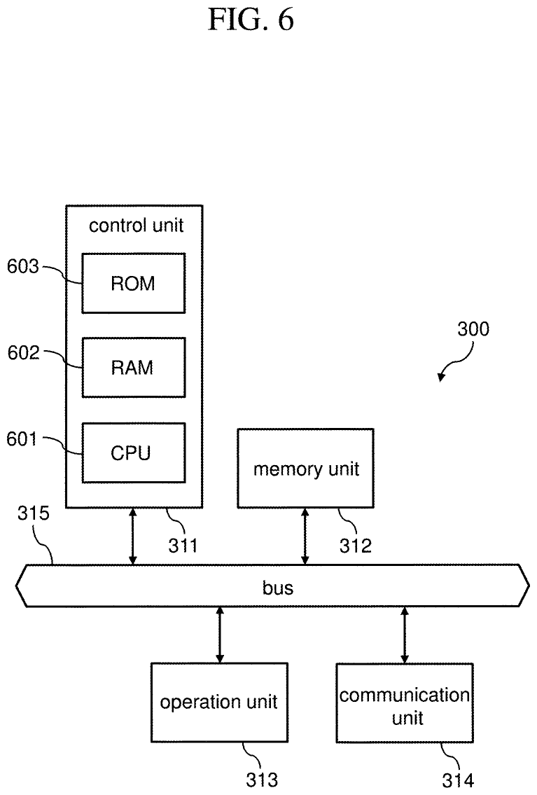

FIG. 6 is a block diagram showing a configuration of the supply unit 300. The supply unit 300 includes a control unit 311, a memory unit 312, an operation unit 313, and a communication unit 314. The supply unit 300 may be a mobile terminal device such as a smart phone. Each of elements of the supply unit 300 is connected to each other by a bus 315.

The control unit 311 includes a calculation device such as a CPU (Central Processing Unit) 601 and a memory device such as a RAM (Random Access Memory) 602 and a ROM (Read Only Memory) 603. The CPU 601 controls each element of the supply unit 300 based on the control program stored in the ROM 603. The ROM 603 readably stores various computer programs executed by the CPU 601, various table data referred to when the CPU 601 executes a predetermined computer program, and the like. The RAM 602 is used as a working memory for temporarily storing various data generated when the CPU 601 executes a predetermined computer program. Alternatively, the RAM 602 may be used as a memory or the like for temporarily storing running computer programs and their associated data.

The memory unit 312 stores the sound data acquired via the communication unit 314. In addition, the memory unit 312 may store the performance data acquired from the server 400, which will be described later. In this case, the sound data and the performance data are stored associated with each other so as to be reproduced in synchronization. In addition, the memory unit 312 may store the music data. The control unit 311 reads out the sound data and the performance data associated with the sound data from the memory unit 312 based on a user's music reproduction instruction input to the operation unit 313. The control unit 311 supplies the sound data to the speaker device 100 and the performance data to the keyboard device 200 in synchronization with each other via the communication unit 314. In the present embodiment, although the memory unit 312 is described as an element of the supply unit 300, the present disclosure is not limited to this. For example, the memory unit 312 may be realized by an external memory device or a memory unit of an external server. In this case, the supply unit 300 and the external device are connected via a network, and the supply unit 300 reads out the sound data and the performance data associated with the sound data stored in the external device based on the user's music reproduction instruction input to the operation unit 313.

The operation unit 313 is the operation button, the touch panel, or the like that receives the user's operation. When the user's operation is input to the operation unit 313, an operation signal corresponding to the input operation is output to the control unit 311. For example, the operation signal includes music designation information for designating a music desired by the user, musical instrument designation information for designating a desired musical instrument sound, and the music reproduction instruction for instructing reproduction of the music.

The communication unit 314 is an interface that communicates with other devices wirelessly or by wire. The interface may be connected to the disk drive that reads out various data recorded in a recording medium such as a DVD (Digital Versatile Disk) or a CD (Compact Disk) and outputs the read data, or may be connected to a semiconductor memory or the like, or may be connected to an external device such as a server via a network. The supply unit 300 can acquire desired music data such as MP3 from a digital sound source recorded in the recording medium such as the CD or the external server or the like via the communication unit 314 according to the music designation information. The music data may be the audio signal containing the performance sound of one or more musical instruments. In addition, the supply unit 300 supplies the sound data read according to the user's music reproduction instruction to the speaker device 100 and supplies the performance data associated with the sound data to the keyboard device 200 via the communication unit 314.

The control unit 311 may adjust the timing to start the sound generation based on the sound data with respect to the timing to start driving the key based on the performance data before transmitting the sound data to the speaker device 100 and the performance data to the keyboard device 200, respectively. Specifically, the control unit 311 may execute delay processing for delaying the sound data by a predetermined time relative to the performance data. The predetermined time may be a preset time, for example, 0.5 sec, and may be a time set by the user via the operation unit 313 or the like.

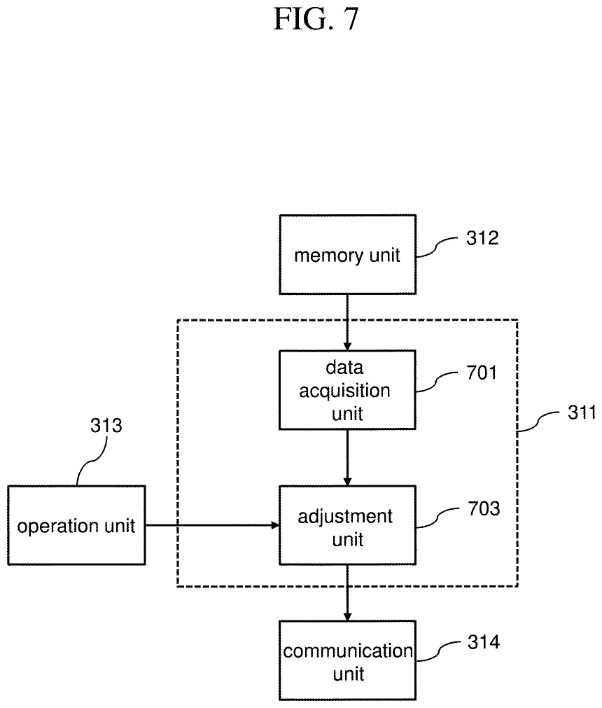

FIG. 7 is a diagram showing a functional configuration of the control unit 311. The control unit 311 includes a data acquisition unit 701 and an adjustment unit 703. The functions of the data acquisition unit 701 and the adjustment unit 703 described below may be executed by the CPU 601 of the control unit 311.

The data acquisition unit 701 reads out and acquires the sound data and the performance data associated with the sound data from the memory unit 312 based on the user's instruction input to the operation unit 313. The data acquisition unit 701 outputs the acquired sound data and the performance data to the adjustment unit 703.

The adjustment unit 703 receives the sound data and the performance data and adjusts the timing to start the sound generation based on the sound data with respect to the timing to start driving the key based on the performance data. Specifically, the adjustment unit 703 performs delay processing for delaying the sound data by a predetermined time relative to the performance data. For example, the delay processing may include processing of inserting a silence period corresponding to a predetermined period at the beginning of the sound data in order to delay the timing to start emitting the sound from the speaker device 100 by a predetermined time with respect to the timing to start driving the key in the keyboard device 200 based on the performance data. Alternatively, the delay processing may include processing to delay the timing to start transmitting the sound data to the speaker device 100 for a predetermined time with respect to the timing to start transmitting the performance data to the keyboard device 200. Alternatively, the delay processing may include shifting the time to start a performance event forward by a predetermined time with respect to the time to start the sound emission based on the sound data. In this case, the timing of the performance event information included in the performance data, which is defined on the time axis determined depending on the tempo and duration, may be shifted forward by a predetermined time. As described above, the predetermined time is also referred to as the delay time, and may be a preset time, for example, 0.5 sec. In addition, the user can also change the delay time via the operation unit 313 for each music.

In the case of an acoustic piano, an interval is confirmed from when the key is pressed to when it is actually sounded. This interval corresponds to the time the time it takes for the hammer to operate in response to a key press and for the hammer to strike the string corresponding to the key pressed. Delaying the sound data relative to the performance data by the adjustment unit 703 makes it possible to enhance the reproducibility of the sound generation of the acoustic piano in the sound output system 10. In addition, in an acoustic piano, the interval from when the key is pressed to when the sound is actually generated is different depending on the key press speed. In an acoustic piano, the smaller the key press speed, the larger the interval. Therefore, in the sound output system 10, it is possible to further enhance the reproducibility of the sound generation of the acoustic piano by changing the time to delay the sound data relative to the performance data (that is, the delay time) according to the strength of the sound in the music. In addition, in the keyboard device 200, an interval is confirmed from the note-on included in the performance data to the corresponding key 202 is actually driven by the key drive unit 230. This interval may cause sound corresponding to the key 202 to be emitted from the speaker device 100 before the key 202 is driven. Delaying the sound data relative to the performance data by the adjustment unit 703 makes it possible to prevent the sound corresponding to the key 202 from being emitted from the speaker device 100 before the key 202 is driven and to reproduce a more natural performance.

### [5. Configuration of Server]

Referring back to FIG. 1, the server 400 will be described. The supply unit 300 transmits the acquired music data to the server 400. In this case, the supply unit 300 may supply the musical instrument designation information together with the music data to the server 400. The server 400 processes the music data acquired from the supply unit 300 to generate the sound data. The server 400 automatically generate the performance data in a MIDI format based on the generated sound data, and supply the generated sound data and performance data associated with each other to the supply unit 300.

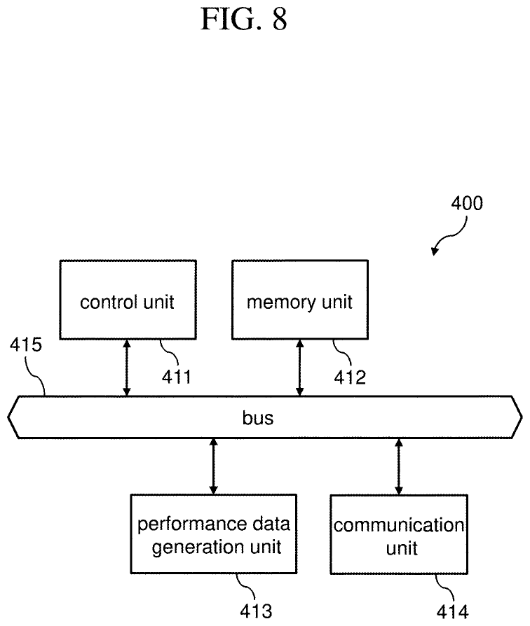

FIG. 8 is a block diagram showing a configuration of the server 400. The server 400 includes a control unit 411, a memory unit 412, a performance data generation unit 413, and a communication unit 414. Each configuration of the server 400 is connected to each other via a bus 415.

The control unit 411 includes the calculation device such as the CPU (Central Processing Unit), and the memory device such as the ROM (Read Only Memory), the RAM (Random Access Memory) and the like. The control unit 411 controls each element of the server 400 based on the control program stored in the memory device. In this example, the control unit 411 executes the control program to execute an auto generation function of the performance data based on the sound data.

The memory unit 412 stores the music data, the musical instrument designation information, and the like acquired via the communication unit 414. The music data and the musical instrument designation information are supplied to the performance data generation unit 413, which will be described later. In addition, the memory unit 412 may store the performance data generated by the performance data generation unit 413. In this case, the sound data and the performance data are stored associated with each other.

The performance data generation unit 413 generates the performance data based on the sound data. The performance data is data corresponding to the sound data, and is, for example, the MIDI data. In the case where the music data includes the sound content of a plurality of musical instruments, the performance data generation unit 413 generates the performance data based on the sound content of a predetermined musical instrument desired by the user based on the musical instrument designation information.

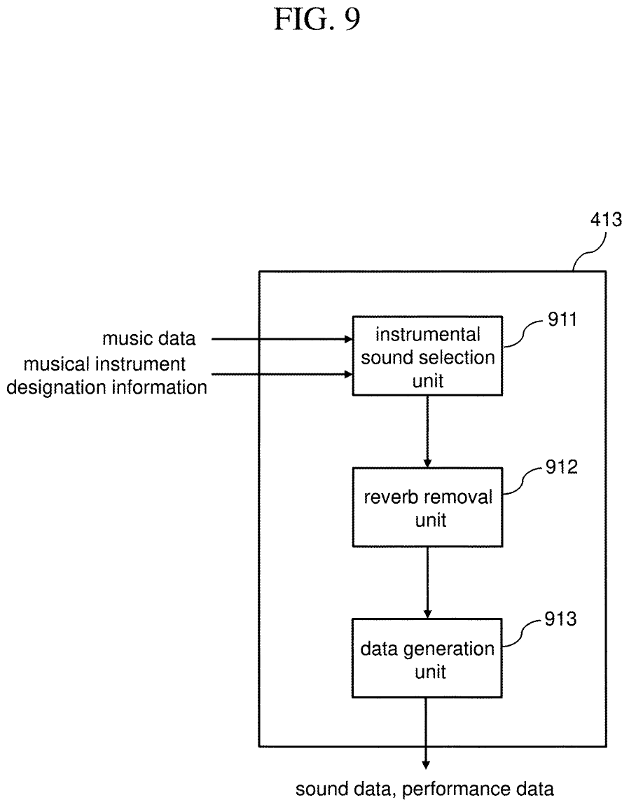

FIG. 9 is a block diagram showing a configuration of the performance data generation unit 413. The performance data generation unit 413 includes an instrumental sound selection unit 911, a reverb removal unit 912, and a data generation unit 913.

In the case where the music data acquired from the supply unit 300 contains the sound content of a plurality of musical instruments, the music data is supplied to the instrumental sound selection unit 911 together with the musical instrument designation information. The instrumental sound selection unit 911 extracts, from the music data, music data indicating the sound content of a predetermined musical instrument based on the music designation data. The instrumental sound selection unit 911 supplies the reverb removal unit 912 with the music data extracted based on the musical instrument designation information. In addition, in the case where the music data acquired from the supply unit 300 contains only the sound content of one musical instrument, extraction processing of the predetermined music data by the instrumental sound selection unit 911 is omitted. In this case, the music data acquired from the supply unit 300 may be directly supplied to the reverb removal unit 912.

The reverb removal unit 912 removes a reverb component from the acquired music data to generate the sound data. Specifically, the reverb removal unit 912 analyzes the music data and removes echo, reverb, noise, and other unclear components (for example, sound components other than the sound with strong attack) from the music data to generate the sound data. The reverb removal unit 912 supplies the sound data subjected to the reverb removal processing to the data generation unit 913.

The data generation unit 913 generates the performance data based on the acquired sound data. As described above, the performance data is control data in which the performance content is defined by a sound generation/stop control according to the time progress and is the MIDI data including performance information such as the pitch information for designating the pitch of the sound content and period information for defining a sound generation period. The data generation unit 913 outputs the sound data and the performance data generated based on the sound data associated with each other. The sound data and the performance data output from the data generation unit 913 are stored in the memory unit 412. In addition, the sound data and the performance data output from the data generation unit 913 may be stored associated with each other in an external memory device.

The supply unit 300 reads out the sound data and the performance data corresponding to the sound data from the server 400 or an external memory device according to the operation input by the user. The supply unit 300 supplies the acquired sound data to the speaker device 100 and the performance data to the keyboard device 200, respectively, in synchronization with each other.

As described above, in the sound output system 10 according to the present embodiment, when the auto play mode and the mute setting are applied to the keyboard device 200, in the keyboard device 200, the key 202 is driven by the key drive unit 230 without generating string hitting sound, and at the same time, sound based on the sound data that is the audio signal is output from the speaker device 100. The sound data includes the audio information obtained at the time of recording. Therefore, the sound output system 10 can reproduce an accurate performance sound at the time of recording. The user can confirm the correct performance sound at the time of recording, and can view the action of the key 202 and the pedal 203 in the keyboard device 200.

Further, the sound based on the sound data in which the reverb component has been removed is output from the speaker device 100, and thus the reverberation corresponding to a space in which the sound is emitted is added to the sound. Therefore, the user can enjoy a more natural sound suitable for the space.

### MODIFICATIONS

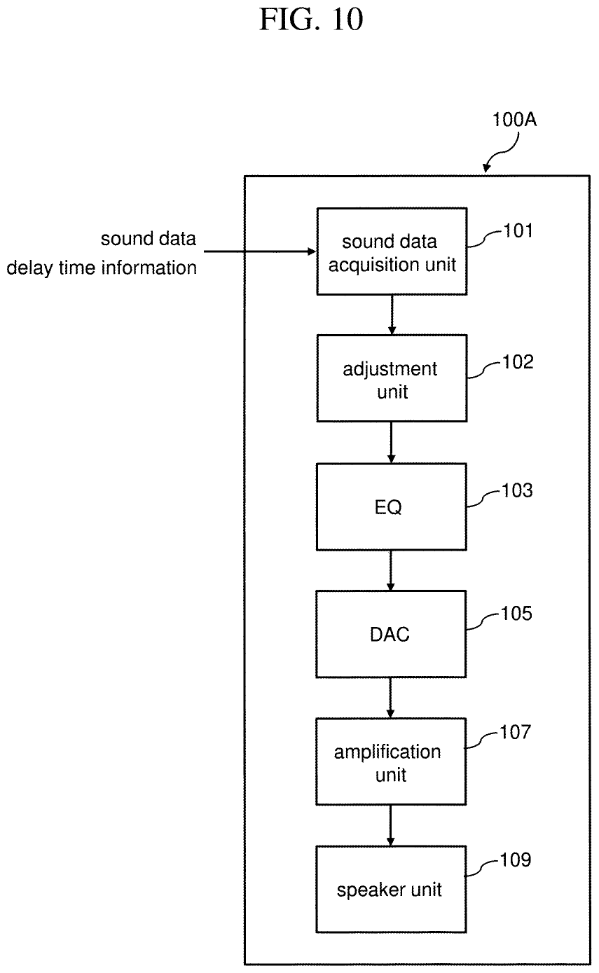

Although an embodiment of the present disclosure has been described above, the present invention can be implemented in various aspects as follows.
(1) The keyboard device 200 may be a sound generating device that includes an operator other than a key. Examples of such a sound generating device include a drum, a cymbal, and a wind instrument. In addition, a device that includes only an operator and does not have a sound generation function may be used. All of the sound generating device and the device having no sound generating function may be the operation device.
(2) In the embodiments described above, the supply unit 300 has been described as a device that is independent of the keyboard device 200. However, the supply unit 300 may be included in the keyboard device 200. In this case, the keyboard device 200 supplies the sound data to the speaker device 100 in synchronization with the performance data.
(3) In the above-described embodiment, the server 400 has been described as a device that is independent of the supply unit 300. However, the server 400 may be included in the supply unit 300. In this case, the function of the server 400 is executed by the supply unit 300. The supply unit 300 generates sound data from the music data, and generates performance data based on the sound data. The supply unit 300 supplies the sound data to the speaker device 100 in synchronization with the performance data, and supplies the performance data to the keyboard device 200 in synchronization with the sound data.
(4) In the embodiments described above, the server 400 have been described as a device that is independent of the keyboard device 200. However, the server 400 may be included in the keyboard device 200. In this case, the function of the server 400 is executed by the keyboard device 200. The keyboard device 200 generates the sound data from the music data, and generates the performance data based on the sound data. The keyboard device 200 supplies the sound data to the speaker device 100 in synchronization with the performance data.
(5) Both the supply unit 300 and the server 400 may be included in the keyboard device 200.
(6) In the above-described embodiment, in the case where the music data includes the sound content of a plurality of musical instruments, the instrumental sound selection unit 911 of the server 400 extracts the music data of a predetermined musical instrument according to the musical instrument designation information, and the extracted music data is subjected to the reverb removal processing to generate the sound data and the performance data. The generated performance data and the corresponding sound data are stored associated with each other and supplied to the supply unit 300. However, the sound data supplied from the supply unit 300 to the speaker device 100 may be the music data including the sound content of a plurality of musical instruments. That is, the music data that has not been processed by the instrumental sound selection unit 911 and the reverb removal unit 912 may be supplied to the supply unit 300 associated with the performance data as the sound data. The user can confirm the action of the operator of the desired musical instrument in the keyboard device 200 and enjoy the ensemble of a plurality of musical instruments including the desired musical instrument.
(7) In the keyboard device 200, when the user selects the auto play mode and the mute setting, the supply unit 300 may read out the music data and output the music data and an instruction signal to the server 400 so as to generate the sound data and the performance data. In this case, the supply unit 300 may inquire the keyboard device 200 about the music designation information and the musical instrument designation information when detecting that the user has selected the auto play mode and the mute setting.
(8) When the supply unit 300 reads out the music data based on the operation input from the user, the keyboard device 200 may automatically change the operation mode to the auto play mode and the mute setting. In this case, the user may input the music designation information and the musical instrument designation information via the operation unit 313 of the supply unit 300.
(9) In the above-described embodiment, it has been described that the supply unit 300 executes the delay processing for delaying the sound data by a predetermined time relative to the performance data. However, this delay processing may be executed in the speaker device 100. FIG. 10 is a diagram showing a configuration of a speaker device 100A according to the present modification. The configuration of the speaker device 100A is substantially the same as the configuration of the speaker device 100 shown in FIG. 2 except that an adjustment unit 102 is included.

The sound data acquisition unit 101 acquires delay time information for delaying the sound data relative to the performance data by a predetermined time together with the sound data from the supply unit 300 and supplies the sound data and the delay time information to the adjustment unit 102. The adjustment unit 102 executes the delay processing for delaying the sound data by a predetermined time relative to the performance data based on the acquired sound data and the delay time information. In this case, the delay processing may include the processing of inserting a silent period corresponding to the predetermined time at the beginning of the sound data in order to delay the timing to start emitting the sound from the speaker device 100A by the predetermined time. The adjustment unit 102 supplies the delay processed sound data to the equalizer 103. In addition, in the present modification, the timing at which the delay processing is executed on the sound data by the adjustment unit 102 is not limited to the timing before the frequency characteristic of the sound data is adjusted by the equalizer 103. The timing at which the delay processing is executed may be the timing after the sound data acquisition unit 101 acquires the sound data and the delay time information, and before the speaker unit 109 acquires the sound data amplified by the amplification unit 107.
(10) In the above-described embodiment, it has been described that the supply unit 300 executes the delay processing for delaying the sound data by a predetermined time relative to the performance data. However, the delay processing may be executed by the server 400. For example, the delay processing may be executed in the performance data generation unit 413. In this case, the performance data generation unit 413 acquires the delay time information together with the music data from the supply unit 300. The data generation unit 913 of the performance data generation unit 413 executes the delay processing for delaying the sound data by a predetermined time relative to the performance data based on the delay time information. The delay processing here is the same as the delay processing executed by the adjustment unit 703 described above.
(11) In the above-described embodiment, it has been described that the speaker device 100 sequentially emits sound based on the sound data supplied from the supply unit 300, and the keyboard device 200 sequentially generates the key control signal based on the performance data supplied from the supply unit 300. However, the present disclosure is not limited to this. The supply unit 300 may transmit the sound data to the speaker device 100 and transmit the performance data to a keyboard device 200 in response to receiving a data transmitting instruction from the user. The speaker device 100 may store the sound data supplied from the supply unit 300 as one data file, and may start sound emission based on the sound data when the receiving music reproduction instruction from the user via the supply unit 300. Similarly, the keyboard device 200 may store the performance data supplied from the supply unit 300 as one data file, and may start generating the key control signal based on the performance data when receiving the music reproduction instruction from the user via the supply unit 300.

In this case, in the case where the sound data is delayed by a predetermined time relative to the performance data, the supply unit 300 may delay the timing of transmitting the music reproduction instruction to the speaker device 100 by a predetermined time from the timing of transmitting the music reproduction instruction to the keyboard device 200. Alternatively, the supply unit 300 may shift the timing of transmitting the music reproduction instruction to the keyboard device 200 to a predetermined time earlier than the timing of transmitting the music reproduction instruction to the speaker device 100.
(12) In the above-described embodiment, it has been described that key 202 is driven by the key drive unit 230 in the keyboard device 200. However, the present disclosure is not limited to this. For example, instead of the configuration in which the key 202 is driven, or in addition to the configuration in which the key 202 is driven, the light emission of a light-emitting unit built into the key may be controlled based on the performance data.

The above-described embodiment as an embodiment of the present disclosure and modifications can be appropriately combined as long as no contradiction is caused. Further, the addition, deletion, or design change of components, or the addition, deletion, or condition change of process as appropriate by those skilled in the art based on a configuration of the present embodiment are also included in the scope of the present invention as long as they are provided with the gist of the present disclosure.

What is claimed is:

1. A sound output system comprising:
a speaker configured to output a sound according to sound data supplied to the speaker; and
an operation device comprising:
one or more operators,
a drive unit configured to drive the one or more operators based on performance data supplied to the operation device in synchronization with the sound data supplied to the speaker, and
a drive control unit configured to control the drive unit.

2. The sound output system according to claim 1, wherein the operation device further comprises a supply unit configured to supply the sound data to the speaker and supply the performance data to the drive control unit.

3. The sound output system according to claim 1, further comprising a performance data generation unit configured to generate the performance data based on the sound data.

4. The sound output system according to claim 1, further comprising a supply unit configured to supply the sound data to the speaker and supply the performance data to the drive control unit.

5. The sound output system according to claim 4, further comprising a memory unit configured to store the sound data and the performance data in association with each other,
wherein the supply unit is configured to read out the sound data and the performance data from the memory unit.

6. The sound output system according to claim 3, wherein
the sound data corresponds to a performance sound including one or more instrumental sounds, and
the performance data generation unit is configured to generate the performance data based on sound data corresponding to a predetermined instrumental sound among the one or more instrumental sounds.

7. The sound output system according to claim 3, further comprising a reverb processing unit configured to remove a reverb component from music data having the reverb component to thereby generate the sound data.

8. The sound output system according to claim 1, further comprising an adjustment unit configured to perform delay processing such that the performance data is supplied to the operation device in synchronization with the sound data being supplied to the speaker by delaying the sound data relative to the performance data.

9. The sound output system according to claim 1, wherein
the operation device is a keyboard device comprising a plurality of keys as the one or more operators,
the keyboard device comprises:
a plurality of hammers respectively interlocked with the plurality of keys;
a stopper that prevents the plurality of hammers from striking a string;
a stopper drive unit that drives the stopper; and
a stopper drive control unit that controls the stopper drive unit, and
the stopper drive control unit controls the stopper drive unit to drive the stopper to prevent the plurality of hammers from striking the string while the drive unit drives the plurality of keys in synchronization with the output of the sound, according to the sound data, by the speaker.

10. The sound output system according to claim 1, wherein
the operation device is operable in a manual performance mode and an auto play performance mode different from the manual performance mode,
in a case where a first setting is applied to the operation device operating in the manual performance mode, a sound source unit of the operation device is configured to generate and output an audio signal corresponding to an operation of the one or more operators, and
in a case where the first setting is applied to the operation device operating in the auto play performance mode, the speaker is configured to output the sound according to the sound data supplied to the speaker, and the sound source unit of the operation device is configured to not generate and output the audio signal corresponding to the operation of the one or more operators.

11. The sound output system according to claim 1, wherein
the operation device is operable in a first auto play mode and a second auto play mode different from the first auto play mode,
in a case where the operation device operates in the first auto play mode, a sound source unit of the operation device is configured to generate and output an audio signal corresponding to the performance data supplied to the operation device, and
in a case where the operation device operates the second auto play mode, the speaker is configured to output the sound according to the sound data supplied to the speaker, and the sound source unit of the operation device is configured to not generate and output the audio signal corresponding to the performance data supplied to the operation device.
